(19) United States
(12) Patent Application Publication
(10) Pub. No.: US 2001/0012041 A1
(43) Pub. Date: Aug. 9, 2001

(54) LEAK RESISTANT INK-JET PEN

(75) Inventors: MELISSA D. BOYD, CORVALLIS, OR (US); KENNETH L. CHRISTENSEN, CORVALLIS, OR (US); JULIE JO BOSTATER, MANHATTAN, KS (US)

Correspondence Address: HEWLETT-PACKARD COMPANY, INTELLECUAL PROPERTY ADMINISTRATION, P O BOX 272400, FORT COLLINS, CO, 805289599

(73) Assignee: HEWLETT-PACKARD COMPANY

(21) Appl. No.: 09/455,893

(22) Filed: Dec. 6, 1999

Related U.S. Application Data
(63) Continuation of application No. 08/389,608, filed on Feb. 15, 1995, now abandoned.
Application No. 08/389,608 is a continuation of application No. 08/075,357, filed on Jun. 9, 1993, now abandoned.
Application No. 08/075,357 is a continuation of application No. 07/752,158, filed on Aug. 29, 1991, now abandoned.

(51) Int. Cl. B41J 2/19

(52) U.S. Cl. 347/92

(57) ABSTRACT

A three-color ink-jet cartridge has a conduit connecting an ink reservoir to a print head orifice. The conduit has a pair of internal longitudinal grooves to permit ink to flow past a trapped bubble in the conduit. This ink flow prevents ink leakage through the orifice when ambient pressure changes cause the trapped bubble to expand.

This invention relates to ink-jet pens for use in computer printers.

### BACKGROUND AND SUMMARY OF INVENTION

Ink-jet printers are an effective means for printing information and graphics in conjunction with personal computer work stations, for instance. An ink-jet cartridge or pen is the heart of such a printer. The ink-jet pen typically has a reservoir of liquid ink with a conduit supplying the ink to a print head, which is electrically controlled to expel droplets of ink onto an adjacent piece of paper.

A multi-color ink-jet pen includes three reservoirs, each containing an open-cell foam sponge retaining a different color ink. Each reservoir is vented to ambient pressure. A separate conduit connects each reservoir to a print head, which has an array of orifices for expelling each ink color separately. The high capillarity of the foam sufficiently resists ink flow from the reservoir so that a slight backpressure may be established at the print head to prevent ink leakage through the orifices.

During manufacture, while the reservoirs are being filled with ink, air remaining in the conduits is substantially removed by applying suction to the orifices. Nonetheless, it is common for an air bubble to remain in a conduit after this priming process.

Normally, an increase in ambient temperature or decrease in ambient pressure will create some expansion of a trapped air bubble within the conduit. When such expansion occurs, the high-capillarity foam wicks the expanded volume of ink from the conduits back into the reservoirs, thereby preventing leakage from the orifices. This wicking effect occurs as long as there remains a continuous path of ink between the foam and the orifice.

When a large air bubble occupies a conduit, it may interrupt the continuous path of ink required for the foam to prevent leakage. This problem is most likely to occur when a bubble entirely occupies a tubular, vertical standpipe portion of the conduit adjacent to the reservoir. A fine mesh screen between the foam and standpipe prevents the bubble from entering the reservoir, trapping the bubble in the standpipe. The trapped bubble may expand as a result of ambient changes and act as a check valve to block the ink path to the reservoir. Consequently, some of the ink between the bubble and the print head is forced out of the orifices because the foam is unable to wick that volume of ink past the blocking bubble.

When one color of ink leaks out of its orifice, it forms a droplet on the print head surface. The droplet may grow to encounter the orifice of another color, which absorbs it, creating a contaminated mixture. This mixture may be further drawn back into the ink pen when pressure and temperature return to normal. Consequently, proper color printing is spoiled at least until the contaminated ink is spent. The cartridge may be entirely ruined if the contamination is allowed to remain for an extended length of time.

The present invention provides an ink-jet cartridge configured to maintain an uninterrupted ink path for transmitting the wicking effect of the foam-filled reservoir through a conduit, even when the conduit is occupied by a significantly large air bubble. A sufficient fluid path to bypass such a bubble is provided by the conduit configuration. The leak-preventing wicking of the foam-filled reservoir is thereby maintained.

### BRIEF DESCRIPTION OF THE DRAWINGS

FIG. 1 is a perspective view of an ink-jet pen apparatus constructed in accordance with the invention.

FIG. 2 is a sectional side view of the apparatus in FIG. 1 taken along line 2-2.

FIG. 3 is a sectional bottom view of the apparatus of FIG. 1 taken along line 3-3 in FIG. 2.

FIG. 4 is a sectional top view of a standpipe taken along line 4-4 in FIG. 2.

FIG. 5 is a sectional side view of a standpipe taken along line 5-5 in FIG. 3.

FIG. 6 is a sectional side view of a standpipe taken along line 6-6 in FIG. 3.

FIG. 7 is a sectional top view taken along line 7-7 in FIG. 6.

### DETAILED DESCRIPTION OF A PREFERRED EMBODIMENT

FIG. 1 shows a three-color ink-jet cartridge 10 having a box-shaped body 12 with a bottom plate 14 attached to and substantially coextensive with the bottom surface of the body 12. A print head 20 is attached to the bottom plate 14. The print head defines three sets of print orifices 22 that provide apertures for expelling ink in a controlled pattern during printing. The print head 20 is electronically controlled by a printer (not shown) through a connector circuit 24 mounted on the body 12.

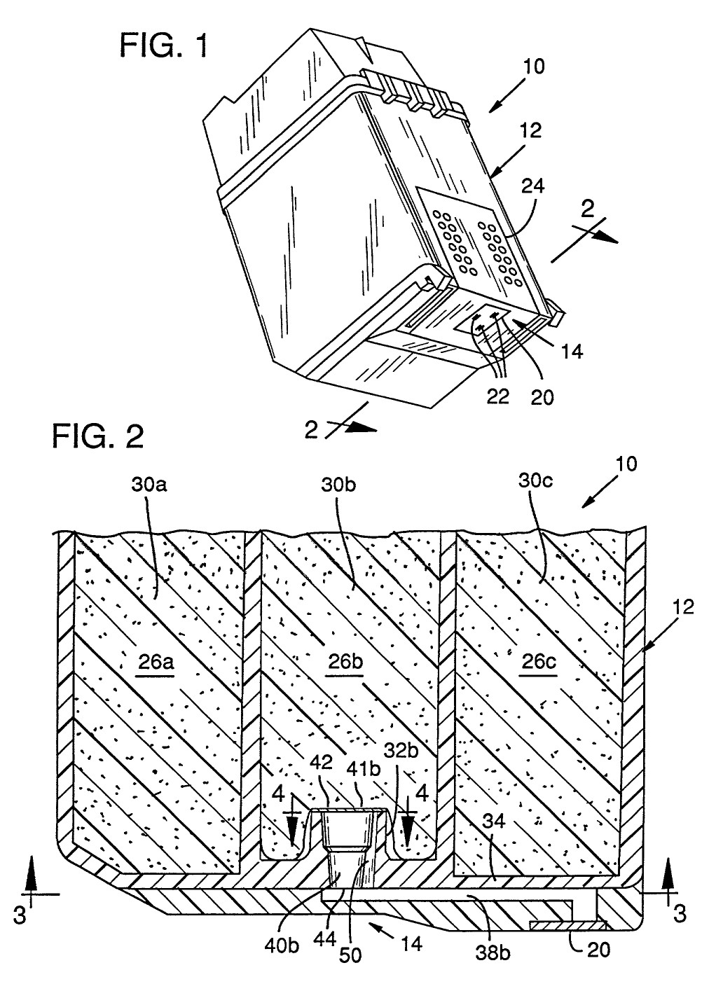

FIG. 2 shows the body 12 defining three similarly sized adjacent ink chambers 26a, 26b, 26c. Each chamber contains a different color ink: cyan, yellow and magenta, for instance. Each chamber is filled with an ink sponge 30a, 30b, 30c formed of open cell foam capable of absorbing and retaining substantial quantities of ink with a wicking effect that tends to draw ink in and prevent ink from leaking out of the sponge.

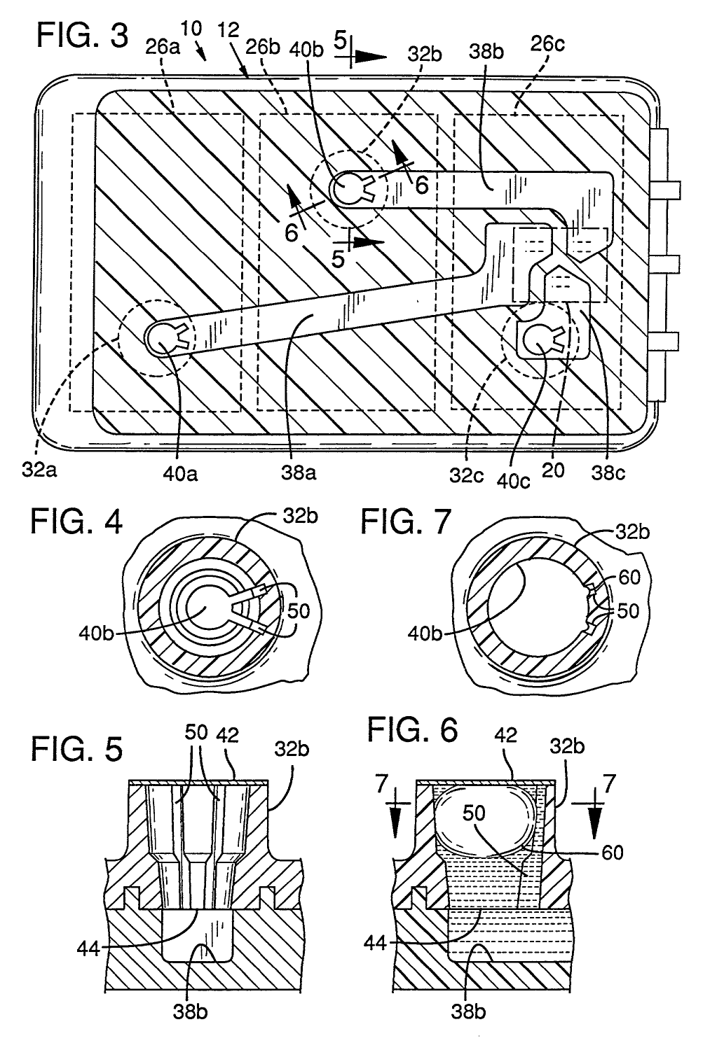

An open, vertical, generally cylindrical standpipe 32a, 32b, 32c (FIG. 3) is integrally attached to the floor of each chamber, each floor being formed by a base wall 34 of the reservoir body 12. Each standpipe 32a, 32b, 32c forms a conduit for fluid communication between its respective chamber 26a, 26b, 26c and a region outside of the reservoir base wall 34. This external region is a lateral ink channel 38a, 38b, 38c formed cooperatively by the bottom plate 14 and the base wall 34 of the reservoir body 12.

As shown in FIG. 3, the lateral channels 38a, 38b, 38c provide separate conduits to transmit ink from each respective standpipe 32a, 32b, 32c to an associated orifice set in the print head 20.

Each standpipe defines a vertical passage 40a, 40b, 40c. Referring to an exemplary one standpipe 32b (FIG. 2), the upper end 41b of each standpipe is covered by a mesh screen 42. Each screen 42 contacts the respective sponge 30b so that the suction provided by the sponge wicking effect may draw fluid from the passage 40b. Each screen 42 is liquid permeable, but is fine meshed to prevent air bubbles or impurities from passing through. The standpipe passage 40b is terminated at its lower end by a relatively narrow aperture portion 44 in communication with the respective lateral channel 38b.

To provide the fundamental advantages of the invention, the preferred configuration of each standpipe passage 40a, 40b, 40c includes a specially formed interior surface. Again referring to an exemplary standpipe 32b, this surface preferably includes a pair of internal grooves 50, as best shown in FIGS. 4 and 5. Each groove 50 provides a continuous path adjacent to the conduit passage 40b between the reservoir 26b and the lateral channel 38b. This cross-sectional configuration preferably extends the entire length of the standpipe 32b. Similar lateral grooves (not shown) may also be formed longitudinally in the lateral channels 38a, 38b, 38c in communication with the print head 20 to prevent bubble blockage therein.

Preferably, as shown in FIG. 5, all of the lateral channels 38a, 38b, 38c have a rectangular cross-section. Alternatively, any non-circular or other shape that lacks a smoothly rounded interior cross-section may be suitable. The vertex or corner regions along the length of the channels define bypass paths that function to allow fluid flow past a large bubble occupying the lateral channel. The bubble will not expand to entirely occupy the corners, which remain filled with ink to maintain a continuous fluid path between the reservoir 26 and the print head 20.

The primary function of the grooves 50 is to prevent air bubbles from completely blocking the passages 40a, 40b, 40c, thereby completely interrupting the fluid path between the reservoir and the print head. As illustrated in FIGS. 6 and 7, the ink surface tension will prevent an air bubble 60 from completely filling the internal groove 50. To penetrate and fill a gap of width W (FIG. 7), a bubble must have sufficient internal pressure to form a cylindrical bubble having a radius of r=W/2 or less. The bubble penetrating the groove is characterized as cylindrical because it would extend along a substantial length of the groove, as shown in FIG. 7. The internal pressure P is the amount by which the bubble pressure exceeds the pressure in the surrounding fluid. For a cylindrical bubble, P=4(ST)/r, where ST is the surface tension of the fluid.

In the range of geometries useful in the instant invention, a bubble will not reach a sufficiently high internal pressure P to fully occupy the groove. Before the critical pressure is reached, the bubble will expand longitudinally within the passage 40 in which it resides.

The preferred embodiment is designed for high surfactant inks with surface tension values in the range of 30 to 35 dynes/cm. The diameter of the primary passage 40 ranges between 0.095 and 0.163 inch as it tapers throughout its height. The grooves 50 preferably have a width of 0.020 inch, and depths of 0.014 to 0.016 inch. The depth-to-width ratio of the grooves is greater than one half so that a nearly semi-cylindrical bubble segment, as would be formed in a limiting case, would not occlude the groove. The groove 50 may be substantially deeper than this limiting ratio, with the added advantage of adequate fluid flow capacity through the groove.

The groove depth is limited only by the dimensions of the pen body 12 in which the grooves 50 are formed. The groove width may be reduced to ensure that even high pressure bubbles will not block the groove, but excessive narrowing will overly constrict the fluid flow through the groove, risking leakage during rapid ambient pressure changes. Extremely narrow grooves are also difficult to manufacture. With the ink formulation used, grooves wider than about 0.040 to 0.050 inch are believed to be inadquate, with this width limit varying proportionately with the surface tension properties of alternative inks employed. A wider groove would require smaller sub-grooves or sharp corners to be effective.

Thus, a continuous path of ink is maintained irrespective of bubble expansion. As a result, the wicking effect of the sponges 30 will be maintained for drawing ink through the groove 50, past a bubble in the standpipe passage and back into the chamber 26, so that the ink will not leak in the event of bubble expansion. There is always maintained a small but effective suction or backpressure throughout the conduit in the lateral channels 38a, 38b, 38c leading to the print head 20.

If the conduit lacked the groove feature and were entirely blocked by a bubble, the wicking effect would be blocked, and environmental changes causing expansion of the bubble would drive ink out of the print head 20. Essentially, the bubble would act as a check valve, with any expansion in the chamber forcing ink out of the orifice, as the bubble cannot penetrate the screen, and the ink cannot circumvent the bubble. In the preferred embodiment, ink downstream of the expanding bubble 60 is influenced by the combined effects of the negative pressure due to wicking by the foam sponge 30 and the neutral pressure of the orifice 22, which resists passage of fluid or air. Thus, the ink is drawn through the capillary groove 50 toward the sponge 30, rather than being forced out of the orifice.

Having illustrated and described the principles of the invention by what is presently a preferred embodiment, it should be apparent to those persons skilled in the art that the illustrated embodiment may be modified without departing from such principles. For example, the lateral channels may be provided with similar grooves to avoid air bubble blockage therein, and the standpipe interior conduit may be formed in any shape, such as a polygon with corners, to permit capillaries of ink to bypass a substantial air bubble, including a plurality of different size passages for each chamber.

In view of the many possible embodiments to which the principles of our invention may be put, it should be recognized that the detailed embodiment is illustrative only and should not be taken as limiting the scope of our invention. Rather, we claim as our invention all such embodiments that may come within the scope and spirit of the following claims and equivalents thereto.

We claim:

1. A pen cartridge comprising:
a body defining a reservoir for storing ink;
an orifice for expelling ink from the reservoir;
the body also defining a conduit for providing ink flow between the reservoir and the orifice; and
the body further defining a path providing ink flow between the reservoir and the orifice when the conduit is blocked.

2. The cartridge of claim 1 wherein the path is a groove adjacent to the conduit.

3. The cartridge of claim 2 wherein the groove has a cross-sectional width substantially less than the cross-sectional width of the conduit.

4. The cartridge of claim 3 wherein the groove has a cross-sectional depth of at least one half the cross sectional width of the conduit.

5. The cartridge of claim 2 wherein the groove has a depth sufficiently deep such that a gas bubble substantially blocking the conduit will not entirely fill the groove.

6. An ink pen comprising:
a body defining a reservoir;
an orifice; and
the body also defining a passage between the reservoir and the orifice, at least a first section of the passage having a cross sectional profile with a wide portion and a narrow portion, such that when the passage is filled with a mixture of ink and air, the air will tend to form a bubble in the wide portion.

7. The pen of claim 6 wherein the first section of the passage is generally vertical during a normal operation of the pen.

8. The pen of claim 6 wherein the wide portion is circular in cross-section and the narrow portion is a groove extending along the length of the passage.

9. The pen of claim 6 wherein the groove has a sufficiently narrow cross-sectional width such that a bubble may not entirely occupy the groove.

10. The pen of claim 6 wherein the groove has a sufficiently deep cross-sectional depth such that a bubble may not entirely occupy the groove.

11. An ink pen comprising:
a body defining a reservoir;
an orifice; and
the body also defining a passage between the reservoir and the orifice, at least a first section of the passage having a cross sectional shape including a wide portion and a narrow portion, such that the narrow portion retains a continuous path of ink along its length when the wide portion is fully occupied by an air bubble.

12. An ink pen comprising:
a body defining a reservoir;
a print head;
the body defining a conduit having a first section with a wall defining an ink passage, with a groove in the wall defining a path adjacent to the ink passage;
the conduit having a second section contiguous with the first section and having a non-circular cross-sectional shape.

13. The pen of claim 12 wherein the second section has a cross-sectional shape including two surfaces joined at a vertex.

14. The pen of claim 12 wherein the second section has a polygonal cross-section.

15. A method of making an ink-jet pen having a body defining an ink reservoir and an orifice, comprising the steps of:
locating a conduit to extend contiguously between the reservoir and the orifice; and
forming in addition to the conduit a path within the body for conducting ink between the reservoir and the orifice.

16. The method of claim 15 wherein the step of forming a path includes defining a groove within the conduit.
